(19) United States
(12) Patent Application Publication
(10) Pub. No.: US 2004/0141719 A1
(43) Pub. Date: Jul. 22, 2004

(54) Control apparatus and recording method

(76) Inventor: Masanori Hashimoto, Miura-shi (JP)

Correspondence Address: NATH & ASSOCIATES, PLLC, Sixth Floor, 1030 15th Street, N.W., Washington, DC, 20005, US

(21) Appl. No.: 10/754,573

(22) Filed: Jan. 12, 2004

(30) Foreign Application Priority Data
Jan. 16, 2003 (JP) P2003-008411

(51) Int. Cl. H04N 5/76; H04N 5/781

(52) U.S. Cl. 386/46; 386/125

(57) ABSTRACT

A plurality of recording subunits connected to a control apparatus are displayed on a GUI screen as a connected-apparatus list. From this list, the user selects a recording subunit on which data is to be recorded and an option, either simultaneous recording or continuous recording, from a recording option on the GUI screen. The control apparatus establishes a transmission route to the selected recording subunit according to the instruction, either simultaneous recording or continuous recording, selected from the recording option.

### BACKGROUND OF THE INVENTION

1. Field of the Invention

The present invention relates to a technology for allowing a control apparatus to control the recording subunits of a plurality of target apparatuses, each controlled by the controller apparatus and having the recording function, in a recording system where the plurality of target apparatuses and the control apparatus (hereinafter called a controller apparatus) are connected via a communication line.

2. Description of the Related Art

A digital serial interface conforming to IEEE (Institute of Electrical and Electronics Engineers) 1394 is known as an interface for interconnecting a plurality of audiovisual (AV) apparatuses.

When a controller apparatus wants to record data on an apparatus that is an operation target (hereinafter called a target apparatus) with the recording function (hereinafter called a recording subunit of a target apparatus) on a network where a plurality of AV apparatuses are connected via an IEEE 1394 serial bus that is a digital serial interface conforming to IEEE 1394, a graphical user interface (GUI) application is conventionally used to select the recording subunit of the target apparatus before recording.

More specifically, in a system shown in FIG. 1, three digital video decks (in this example, D-VHS decks 103, 105, and 107) are connected to a set top box (STB) 101 via an IEEE 1394 serial bus 111, where the STB 101 is a controller, the D-VHS decks 103-107 are target apparatuses, and the serial bus 111 is a communication line. When the user wants to record data from the STB 101 to the D-VHS deck 103 that is one of target apparatuses, the user uses a remote controller to select a subunit of an apparatus connected to the 1394 serial bus 111, in this example, the D-VHS deck 103 which is the control target, from the connected-apparatus list displayed on the GUI screen 113 of the STB 101 as shown in FIG. 2.

Next, when the user selects a record button 145b on the control panel 145 of the STB 101, a connection is established between the STB 101 and the D-VHS deck 103. Then, a record command, one of AV/C commands, is sent from the STB 101, which is the controller, to the tape recorder player subunit (hereinafter called a tape subunit) of the D-VHS deck 103, which is the target apparatus, and recording starts on the D-VHS deck 103.

In addition to the record button 145b, the control panel 145 includes a stop button 145a, a play button 145c, a rewind button 145d, and a fast forward button 145e. AV/C commands, which form a command set defined by the AV/C Digital Interface Command Set General Specification, are communicated via the IEEE 1394 interface. A command is sent, and its response is returned, as an asynchronous WRITE transaction defined by IEEE 1394.

As described above, the user can execute an application on the controller apparatus to record data from the controller apparatus to a recording subunit of a target apparatus through the IEEE 1394 serial bus 111 in a conventional recording system (See Japanese Patent Laid-Open Publication No. 2001-195345).

In a recording system where a plurality of apparatuses are networked such as the one described above, it is supposed that, in the future, more apparatuses will be connected to an IEEE 1394 serial bus and that a subunit with a plurality of recording functions will be installed in one apparatus. When a user wants to record data on a plurality of subunits via the controller apparatus at the same time in such an environment described above, the conventional recording system requires the user to select a target apparatus and, for each recording subunit, to execute the procedure for starting recording. In addition, for a tape subunit in which a video cassette tape is used as a recording medium, the user must switch from one subunit to another when the tape comes near the end during recording. This operation increases the operation load of the user.

### SUMMARY OF THE INVENTION

It is an object of the present invention to provide a control apparatus and a recording method that reduce the load of a user and increase the efficiency of operation when simultaneous recording or continuous recording from a controller apparatus to the recording subunits of a plurality of target apparatuses, each with the recording function, is set up.

To achieve the above object, there is provided a control apparatus connected to a plurality of target apparatuses via a communication line, comprising: recording subunit display means for displaying a list of recording subunits, installed in the plurality of target apparatuses, on a screen; recording subunit selection means for accepting a selection of recording subunits, on which data is to be recorded, from the list of recording subunits displayed on the screen by the recording subunit display means; recording option selection means for accepting a selection of simultaneous recording or continuous recording; the simultaneous recording being a recording mode in which data is recorded simultaneously on the recording subunits selected through the recording subunit selection means, the continuous recording being a recording mode in which data is recorded on the recording subunits, selected through the recording subunit selection means, in an order in which the recording subunits are selected; and transmission route establishment means for establishing a data transmission route of the recording subunits according to which recording mode, simultaneous or continuous, is selected through the recording subunit selection means.

In a preferred embodiment of the present invention, when the simultaneous recording is selected, the transmission route establishment means establishes the data transmission route for the recording subunits selected through the recording subunit selection means and, when the continuous recording is selected, the transmission route establishment means establishes the data transmission route for a recording subunit selected first through the recording subunit selection means and, when the recording subunit selected first becomes inoperable to record data, establishes the data transmission route for a recording subunit selected next through the recording subunit selection means.

To achieve the above object, there is provided a recording method for use in a recording system where a plurality of target apparatuses and a control apparatus are connected via a communication line, the recording method comprising: a recording subunit display step of displaying a list of recording subunits, installed in the plurality of target apparatuses, on a screen; a recording subunit selection step of accepting a selection of recording subunits, on which data is to be recorded, from the displayed list of recording subunits; a recording option selection step of accepting a selection of simultaneous recording or continuous recording; the simultaneous recording being a recording mode in which data is recorded simultaneously on the selected recording subunits, the continuous recording being a recording mode in which data is recorded on the selected recording subunits in an order in which the recording subunits are selected; and a transmission route establishment step of establishing a data transmission route according to which recording mode, simultaneous or continuous, is selected.

In a preferred embodiment of the present invention, when the simultaneous recording is selected, the transmission route establishment step establishes the data transmission route for the recording subunits selected in the recording subunit selection step and, when the continuous recording is selected, the transmission route establishment step establishes the data transmission route for a recording subunit selected first in the recording subunit selection step and, when the recording subunit selected first becomes inoperable to record data, establishes the data transmission route for a recording subunit selected next in the recording subunit selection step.

The nature, principle and utility of the invention will become more apparent from the following detailed description when read in conjunction with the accompanying drawings.

### BRIEF DESCRIPTION OF THE DRAWINGS

In the accompanying drawings:

FIG. 1 is a block diagram showing the configuration of a conventional recording system;

FIG. 2 is a diagram showing an example of the display of a conventional GUI screen;

FIG. 3 is a block diagram showing the configuration of a recording system in an embodiment;

FIG. 4A is a block diagram showing the internal functional configuration of a controller apparatus;

FIG. 4B is a block diagram showing the internal functional configuration of a target apparatus;

FIG. 5 is a flowchart showing the operation flow of simultaneous recording;

FIG. 6 is a diagram showing an example of the display of a GUI screen;

FIG. 7 is a flowchart showing the operation flow of continuous recording; and

FIG. 8 is a diagram showing an example of the display of the GUI screen.

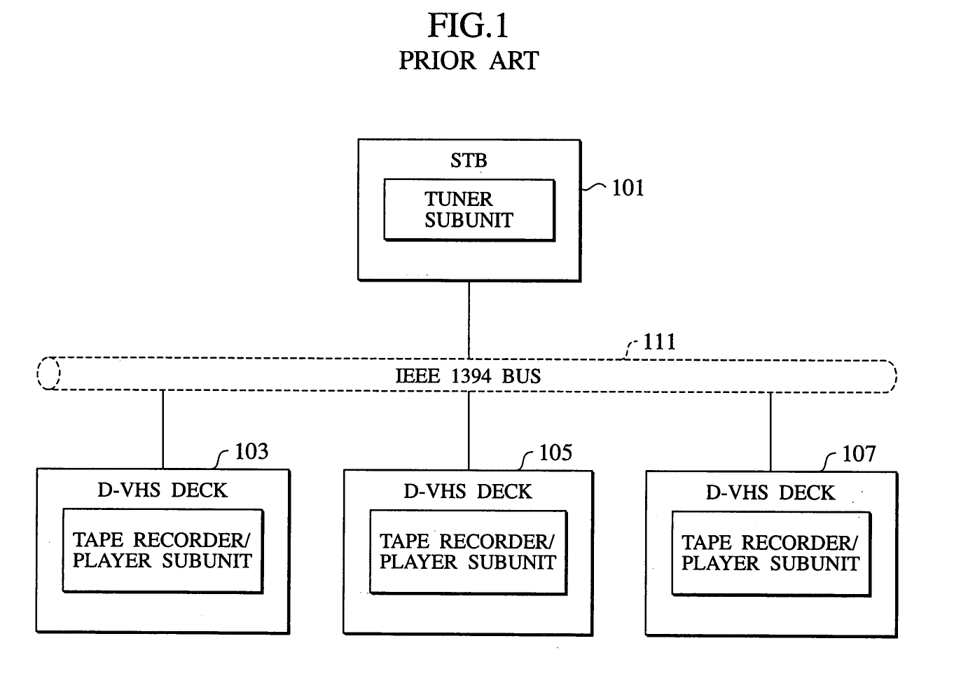

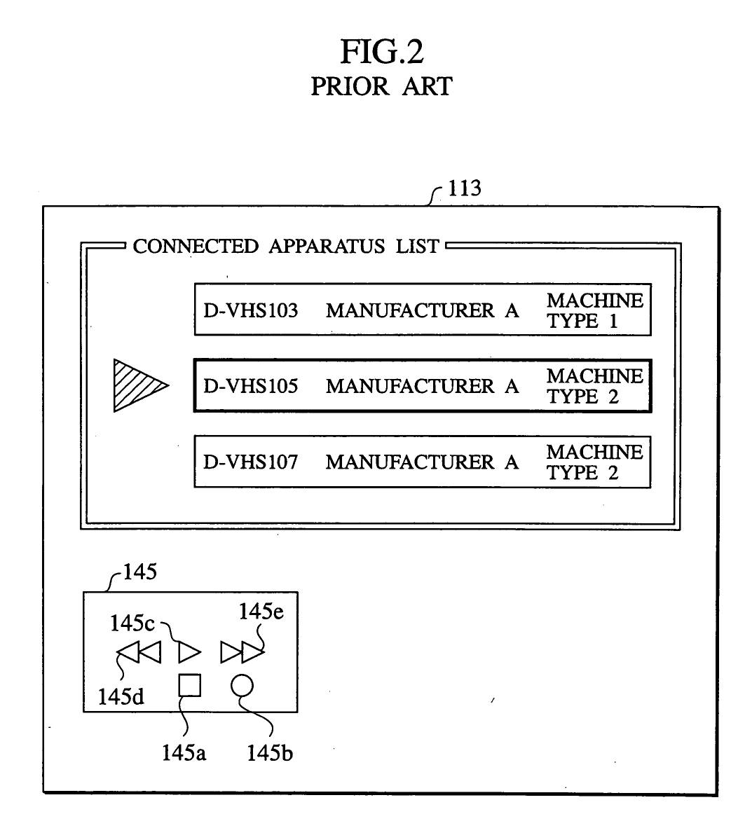

### DESCRIPTION OF THE PREFERRED EMBODIMENTS

An embodiment according to the present invention will be described below with reference to the drawings.

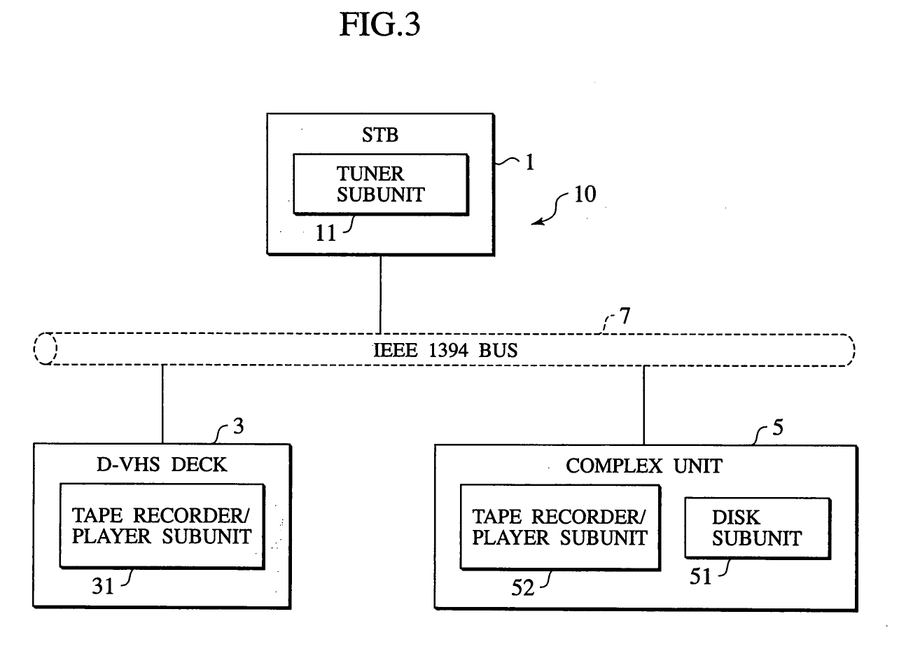

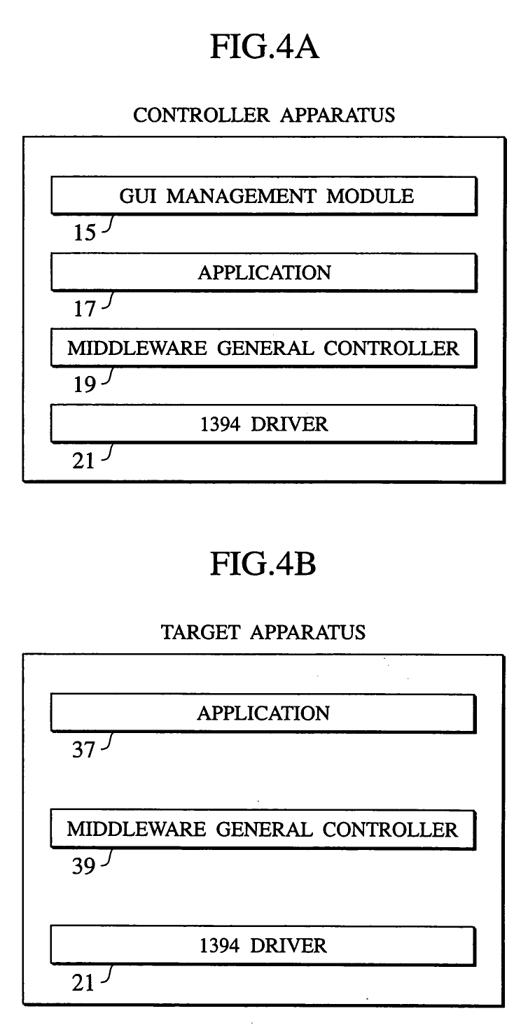

FIG. 3 is a block diagram showing the configuration of a recording system in this embodiment. FIG. 4A is a block diagram showing the internal functional configuration of a controller apparatus, and FIG. 4B is a block diagram showing the internal functional configuration of a target apparatus. In the drawings, the same reference numerals denote the same structural elements.

As shown in FIG. 3, the recording system 10 comprises a controller apparatus, STB 1, to which target apparatuses, a D-VHS deck 3 and a complex unit 5, are connected via an IEEE 1394 serial bus 7.

The controller apparatus STB 1, which is the main unit, integrally controls the target apparatuses connected via the IEEE 1394 serial bus 7. At the same time, the STB 1 includes a tuner subunit 11 to supply television signals, received by the tuner subunit 11, to the target apparatuses as stream data composed of images and audios.

The D-VHS deck 3, a digital video tape deck, includes a tape subunit 31. The complex unit 5, a complex video deck having the digital video deck function and the hard disk video deck function, includes a disk subunit 51 and a tape subunit 52.

The system described above is an exemplary system according to the present invention. Many recording apparatuses, such as a DVD recorder and a hard disk video deck, may be connected as target apparatuses.

As shown in FIG. 4A, the STB 1 comprises a GUI management module 15, an application 17, a middleware general controller 19, and an IEEE 1394 driver 21 to perform its function.

On the other hand, the D-VHS deck 3 and the complex unit 5 each comprise an application 37, a middleware general controller 39, and the IEEE 1394 driver 21, as shown in FIG. 4, to perform their function (The internal function of the D-VHS deck 3 is shown in the figure. The complex unit 5 has the same internal function).

First, the following describes the functions of the components of the STB 1.

The GUI management module 15 displays the GUI screen on the display, such as a television monitor not shown, to which the STB 1 is connected, and manages the operation of the buttons on the GUI screen.

The application 17 in the STB 1 is a software component that controls the STB 1 and controls the connected apparatuses (D-VHS deck 3 and complex unit 5 in this example).

The middleware general controller 19 in the STB 1 controls the IEEE 1394 driver 21 so that a unit-to-unit connection, such as the connection between the STB 1 and the D-VHS deck 3 and between the STB 1 and the complex unit 5, is established and so that a unit-to-subunit connection, such as the connection between the D-VHS deck 3 and the tape subunit 31 and between the complex unit 5 and the disk subunit 51, is established in order to establish a transmission route for isochronous data transmission.

On the other hand, the middleware general controller 39 in the D-VHS deck 3 and the complex unit 5 establishes a unit-to-subunit connection, such as the connection between the D-VHS deck 3 and the tape subunit 31 and between the complex unit 5 and the disk subunit 51.

The IEEE 1394 driver 21, which has the same function both in the STB 1 and in the D-VHS deck 3 and the complex unit 5, performs communication between the apparatuses connected via the IEEE 1394 serial bus 7.

Next, the operation of the recording system 10 configured as described above will be described.

First, the following describes the operation with the use of an example in which a stream received by the STB 1 is recorded on the tape subunit 31 of the D-VHS deck 3 and on the disk subunit 51 of the complex unit 5 simultaneously.

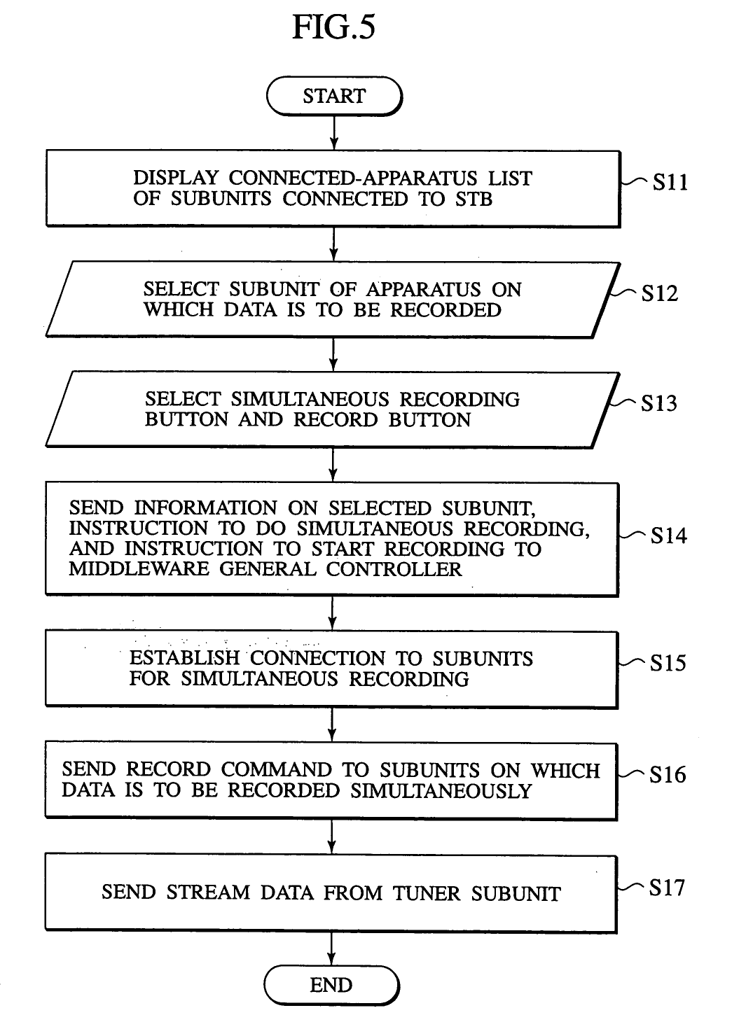

The operation described below is controlled primarily by the CPU, not shown, of the STB 1. The processing of each operation is executed as the function of the recording subunit display means, recording subunit selection means, recording option selection means, and transmission route establishment means in this embodiment. The processing is executed according to a recording control program stored in a memory not shown. This recording control program includes at least the recording subunit display step, recording subunit selection step, recording option selection step, and transmission route establishment step corresponding to the flow in FIG. 5.

FIG. 5 is a flowchart showing the operation flow of simultaneous recording.

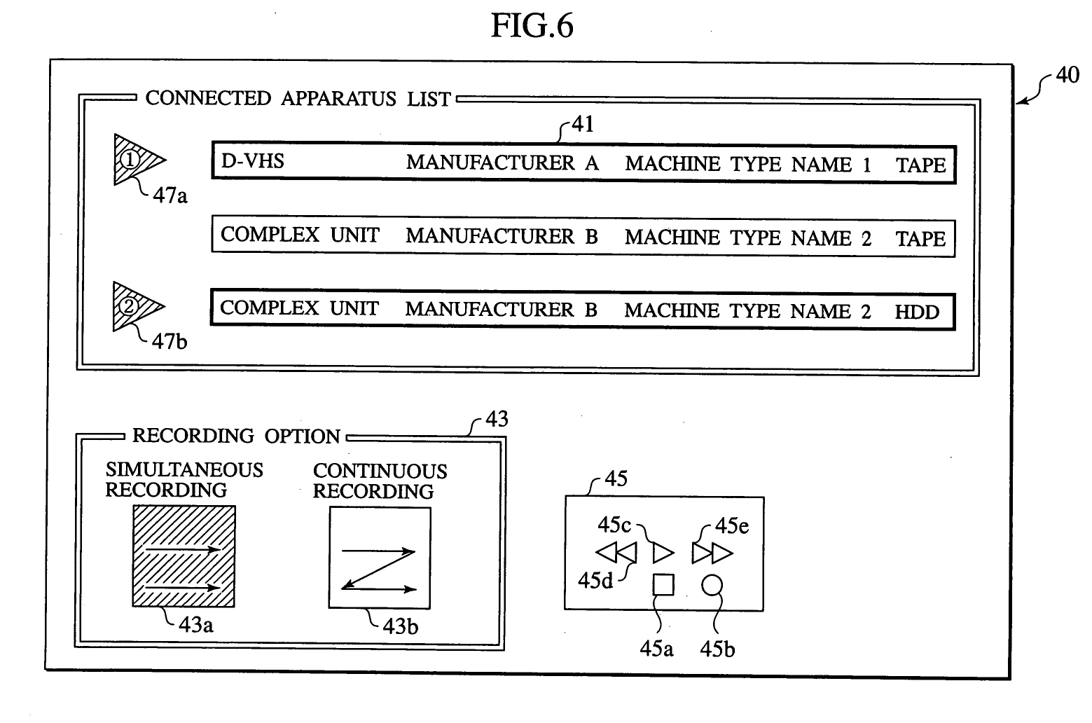

First, the application 17 of the STB 1 provides the GUI management module 15 with a connected-apparatus list consisting of the apparatus names and machine type names of the subunits of the target apparatuses connected to the STB 1. The GUI management module 15 displays the connected-apparatus list, as a GUI screen, on the television monitor connected to the STB 1 (S11). FIG. 6 shows an example of the display on the GUI screen.

On a GUI screen 40, a connected-apparatus list 41, a recording option 43, and a control panel 45 are displayed. The connected-apparatus list 41 includes the apparatus name (D-VHS, complex unit), manufacturer name, (manufacturers A, B), machine type name (machine types 1, 2), and medium (tape, HDD) for each subunit. The recording option 43 includes two buttons: one is a simultaneous recording button 43a used to instruct to record data simultaneously on a plurality of recording subunits selected from the connected-apparatus list 41 and the other is a continuous recording button 43b used to instruct to record data continuously on a plurality of recording subunits selected from the connected-apparatus list 41 in the order in which they are selected. The control panel 45 includes a stop button 45a, a record button 45b, a play button 45c, a rewind button 45d, and a fast forward button 45e.

The user selects the subunit of an apparatus, on which the user wants to record data, from the connected-apparatus list 41 displayed on the GUI screen 40 (S12). In this example, the tape subunit 31 of the D-VHS deck 3 and the disk subunit 51 of the complex unit 5 are selected as shown in FIG. 6, and selection marks 47a and 47b are displayed for the selected subunits in the order in which they are selected. Also, the user selects the simultaneous recording button 43a from the recording option 43 displayed on the GUI screen 40, and then the record button 45b from the control panel 45 (S13).

Then, the GUI management module 15 that manages button operation in the STB 1 sends the information, selected by the user from the GUI screen 40, to the middleware general controller 19 via the application 17 (S14). As described above, this information includes information on the subunit selected for recording, an instruction to do simultaneous recording selected by the simultaneous recording button 43a, and an instruction to start recording operation selected by the record button 45b.

Next, the middleware general controller 19 of the STB 1 instructs the IEEE 1394 driver 21 to establish the connection from the tuner subunit 11 of the STB 1 to the D-VHS deck 3 and to the complex unit 5 and the connection from the D-VHS deck 3 to the tape subunit 31 and from the complex unit 5 to the disk subunit 51 in order to establish a transmission route for isochronous data transmission. Those connections establish a point-to-point connection between the tuner subunit 11 of the STB 1 and each subunit (S15).

Next, the application 17 of the STB 1 sends the RECORD command, one of AV/C commands, to the subunits of the target apparatuses via the IEEE 1394 driver 21 (S16).

This RECORD command causes the subunits of the target apparatuses to start recording and to notify the STB 1 that recording has started. In response to this notification, the STB 1 sends image and audio stream data from the tuner subunit 11 (S17).

The subunits of the target apparatuses (in this example, tape subunit 31 of D-VHS deck 3 and disk subunit 51 of complex unit 5) record the same stream data.

To record data on a plurality of apparatuses, the conventional system requires the user to perform multiple operations individually; that is, the user must select the tape subunit 31 of the D-VHS deck 3 to record data thereon and then select the disk subunit 51 of the complex unit 5 to record data thereon. By contrast, this embodiment requires the user only to select a plurality of subunits from the GUI screen 40 first, to select the simultaneous recording button 43a from the recording option 43, and to press the record button 45b on the control panel 45. This operation establishes the transmission route for use by a plurality of subunits and sends stream data to the tape subunit 31 of the D-VHS deck 3 and to the disk subunit 51 of the complex unit 5, thus making it possible to record data simultaneously.

Although data is recorded simultaneously on the tape subunit 31 of the D-VHS deck 3 and on the disk subunit 51 of the complex unit 5 in the above example, the complex unit may be composed of a plurality of disk subunits or tape subunits. Data can also be recorded simultaneously on a plurality of subunits in the same apparatus in exactly the same way. In addition, for three or more subunits that are identified by the STB 1 as connected to the bus, data can be recorded simultaneously on those subunits in the same way.

Next, the following describes an example in which the recording system 10 in this embodiment switches to another tape subunit 52 or to the disk subunit 51 for continued recording when a tape subunit 31 of the target apparatus comes near the end of tape while recording data from the STB 1 to the tape subunit 31 that is one of the target apparatuses. In the description below, this recording mode is called continuous recording.

In this example, a stream received by the STB 1 is recorded first on the tape subunit 52 of the complex unit 5 and then on the disk subunit 51 of the complex unit 5.

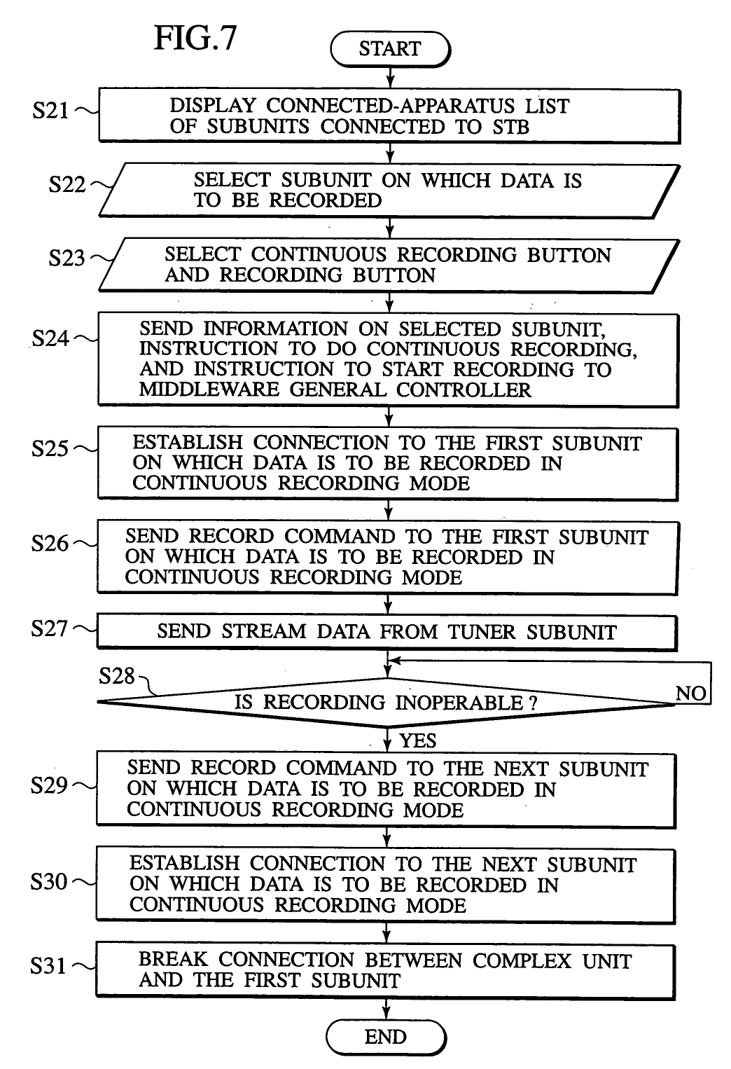

The operation described below is controlled primarily by the CPU, not shown, of the STB 1. The processing of each operation is executed as the function of the recording subunit display means, recording subunit selection means, recording option selection means, and transmission route establishment means in this embodiment. The processing is executed by a recording control program stored in a memory not shown. This recording control program includes at least the recording subunit display step, recording subunit selection step, recording option selection step, and transmission route establishment step corresponding to the flow in FIG. 7.

FIG. 7 is a flowchart showing the operation flow of continuous recording.

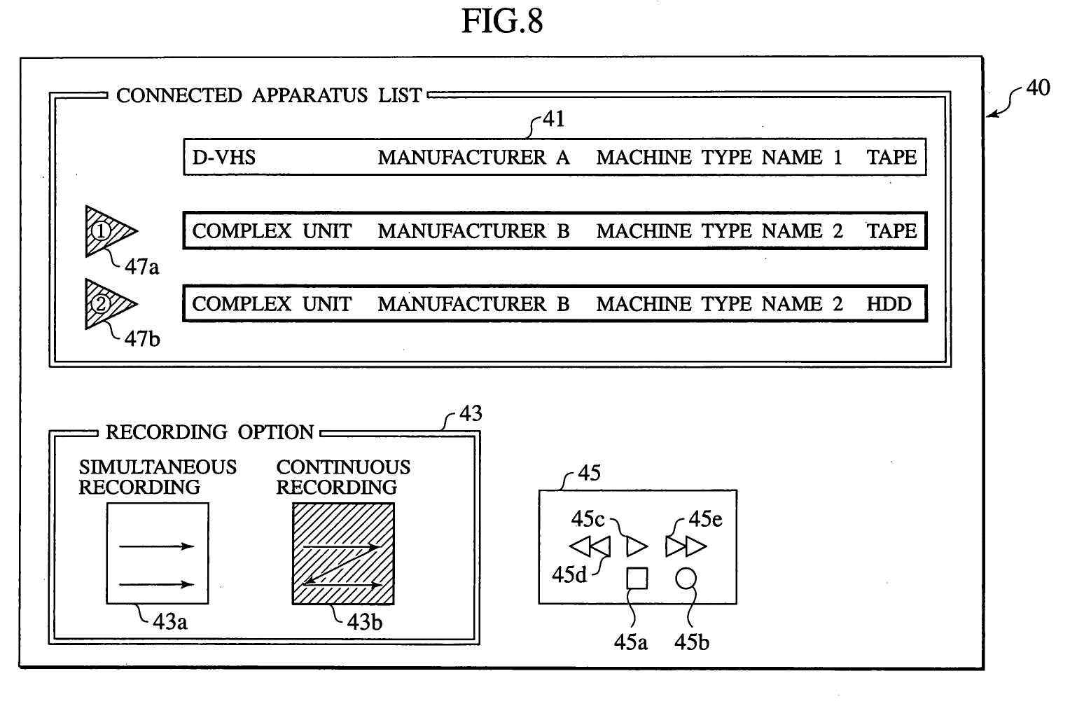

First, the application 17 of the STB 1 provides the GUI management module 15 with a connected-apparatus list, and the GUI management module 15 displays the connected-apparatus list on the GUI screen 40 (S21). FIG. 8 shows an example of the display of the GUI screen.

The connected-apparatus list 41, recording option 43, and control panel 45 are displayed on this GUI screen 40 as in FIG. 7.

The user selects a subunit of the apparatus, on which data is to be recorded, from the connected-apparatus list 41 on the GUI screen 40 (S22). In this example, the user selects the disk subunit 51 of the complex unit 5 and the tape subunit 52 of the complex unit 5 as shown in FIG. 8, and the selection marks 47a and 47b are displayed on the selected subunits in the order in which they are selected. Then, as in the example described above, the user selects continuous recording button 43b from the recording option 43 displayed on the GUI screen 40, and the record button 45b from the control panel 45 (S23).

Then, the GUI management module 15 that manages button operation in the STB 1 sends the information, selected by the user from the GUI screen 40, to the middleware general controller 19 via the application 17 (S24). As described above, this information includes information on the subunits selected for recording, an instruction to do continuous recording selected by the continuous recording button 43b, and an instruction to start recording operation selected by the record button 45b.

Next, the middleware general controller 19 of the STB 1 instructs the IEEE 1394 driver 21 to establish the connection from the tuner subunit 11 of the STB 1 to the complex unit 5 and to the tape subunit 52 in the complex unit 5 in order to establish a transmission route for isochronous data transmission to the first subunit (in this example, tape subunit 52 in complex unit 5) on which continuous recording is to be performed. Those connections establish a point-to-point connection between the tuner subunit 11 of the STB 1 and the tape subunit 52 of the complex unit 5 (S25).

Next, the application 17 of the STB 1 sends the RECORD command, one of AV/C commands, to the tape subunit 52 of the complex unit 5 via the IEEE 1394 driver 21 (S26).

In response to the RECORD command, the tape subunit 52 of the complex unit 5 starts recording and notifies the STB 1 that recording has started. In response to this notification, the STB 1 sends image and audio stream data from the tuner subunit 11 (S27).

Then, the tape subunit 52 of the complex unit 5 starts recording. After a while, the complex unit 5 sends the tape end signal to the STB 1 before the tape comes to the end of tape to indicate that no more data can be recorded on the tape subunit 52 (recording inoperable). Although the tape end signal is sent as recording-inoperable information in this example, information indicating that the disk is full is sent to the STB 1 as the recording-inoperable information when the subunit on which data is recorded first is the disk subunit 51.

The middleware general controller 19 of the STB 1 receives a tape-end notification from the complex unit 5 as information indicating recording-inoperable status (S28: Yes).

In response to the tape end notification, the middleware general controller 19 of the STB 1 instructs the IEEE 1394 driver 21 to establish the connection between the complex unit 5 and the disk subunit 51 in order to establish a transmission route for isochronoous data transmission to the disk subunit 51 that is the next subunit on which data is to be recorded in continuous recording mode. This establishes a point-to-point connection between the tuner subunit 11 of the STB 1 and the disk subunit 51 of the complex unit 5 (S29).

Then, the application 17 of the STB 1 sends the RECORD command, one of AV/C commands, to the disk subunit 51 of the complex unit 5 via the IEEE 1394 driver 21 (S30). In response to the RECORD command, the disk subunit 51 of the complex unit 5 starts recording and notifies the STB 1 that recording has started. At this time, the tuner subunit 11 of the STB 1 keeps on sending stream data, and the disk subunit 51 of the complex unit 5 receives the stream data via the established connection and records the stream data thereon.

Next, the middleware general controller 19 of the STB 1 instructs the IEEE 1394 driver 21 to discard the connection between the complex unit 5 and the tape subunit 52 (first subunit on which data was recorded in continuous mode) to break the connection between the complex unit 5 and the tape subunit 52 (S31). The STB 1 remains connected to the complex unit 5. When the tape comes completely to the end of tape on the tape subunit 52 of the complex unit 5, recording automatically stops.

To switch the recording destination from the tape subunit 52 to the disk subunit 51, the conventional system requires the user to perform switching operation. By contrast, the recording system 10 in this embodiment requires the user only to select a plurality of subunits from the GUI screen 40 first, to select the continuous recording button 43b from the recording option 43, and to press the record button 45b on the control panel. This operation allows the tape subunit 52 of the complex unit 5 to be switched automatically to the disk subunit 51, thus making it possible to record data continuously.

Although data is recorded continuously on the tape subunit 52 and the disk subunit 51 of the complex unit 5 in the above example, data can also be recorded continuously on the complex unit 5 composed of more disk subunits 51 or more tape subunits 52.

Data can also be recorded continuously from a subunit of a target apparatus to a subunit of another target apparatus. In addition, for three or more subunits that are identified by the STB 1 as connected to the bus, data can be recorded continuously on those subunits in the same way.

As described above, the present invention allows the user to record data from a controller side apparatus connected to an IEEE 1394 serial bus to a plurality of recording subunits in one or more target apparatuses simultaneously or continuously simply by selecting a plurality of target apparatuses at a time and by selecting a recording option. Therefore, this system reduces the user load at recording time and increases operation efficiency.

It should be understood that many modifications and adaptations of the invention will become apparent to those skilled in the art and it is intended to encompass such obvious modifications and changes in the scope of the claims appended hereto.

What is claimed is:

1. A control apparatus connected to a plurality of target apparatuses via a communication line, comprising:
recording subunit display means for displaying a list of recording subunits, installed in said plurality of target apparatuses, on a screen;
recording subunit selection means for accepting a selection of recording subunits, on which data is to be recorded, from the list of recording subunits displayed on the screen by said recording subunit display means;
recording option selection means for accepting a selection of simultaneous recording or continuous recording; said simultaneous recording being a recording mode in which data is recorded simultaneously on the recording subunits selected through said recording subunit selection means, said continuous recording being a recording mode in which data is recorded on the recording subunits, selected through said recording subunit selection means, in an order in which the recording subunits are selected; and
transmission route establishment means for establishing a data transmission route of the recording subunits according to which recording mode, simultaneous or continuous, is selected through said recording subunit selection means.

2. The control apparatus according to claim 1 wherein, when said simultaneous recording is selected, said transmission route establishment means establishes the data transmission route for the recording subunits selected through said recording subunit selection means and wherein, when said continuous recording is selected, said transmission route establishment means establishes the data transmission route for a recording subunit selected first through said recording subunit selection means and, when the recording subunit selected first becomes inoperable to record data, establishes the data transmission route for a recording subunit selected next through said recording subunit selection means.

3. A recording method for use in a recording system where a plurality of target apparatuses and a control apparatus are connected via a communication line, said recording method comprising:
a recording subunit display step of displaying a list of recording subunits, installed in said plurality of target apparatuses, on a screen;
a recording subunit selection step of accepting a selection of recording subunits, on which data is to be recorded, from the displayed list of recording subunits;
a recording option selection step of accepting a selection of simultaneous recording or continuous recording;
said simultaneous recording being a recording mode in which data is recorded simultaneously on the selected recording subunits, said continuous recording being a recording mode in which data is recorded on the selected recording subunits in an order in which the recording subunits are selected; and
a transmission route establishment step of establishing a data transmission route according to which recording mode, simultaneous or continuous, is selected.

4. The recording method according to claim 3 wherein, when said simultaneous recording is selected, said transmission route establishment step establishes the data transmission route for the recording subunits selected in said recording subunit selection step and wherein, when said continuous recording is selected, said transmission route establishment step establishes the data transmission route for a recording subunit selected first in said recording subunit selection step and, when the recording subunit selected first becomes inoperable to record data, establishes the data transmission route for a recording subunit selected next in said recording subunit selection step.
